(19) United States
(12) Patent Application Publication
(10) Pub. No.: US 2015/0372367 A1
(43) Pub. Date: Dec. 24, 2015

(54) TRANSMISSION LINE STRUCTURE

(71) Applicant: Golden Bridge Electech Inc., New Taipei City (TW)

(72) Inventor: King-Chung HUANG, New Taipei City (TW)

(21) Appl. No.: 14/479,082

(22) Filed: Sep. 5, 2014

(30) Foreign Application Priority Data
Jun. 18, 2014 (TW) 103210696

(51) Int. Cl. H01P 3/10

(52) U.S. Cl. CPC H01P 3/10

(57) ABSTRACT

A transmission line structure includes a bandage member, a signal transmission member, an extrusion cover member and a temperature-resistant cover member. The bandage member which is formed of a bendable insulating material is shaped as a hollow conduit by winding and has a hollow accommodating space. At least one signal transmission line is disposed in the hollow accommodating space by filler, and the filler is filled between the signal wire and the bandage member. The extrusion cover member covers the outside of the bandage member, and is formed of a bendable plastic insulting material. The temperature-resistant cover member covers the outside of the extrusion cover member, and is formed of a bendable temperature-resistant material. The transmission line structure of the present invention is thereby of better structural strength as well as temperature-resistant characteristic.

### CROSS-REFERENCE TO RELATED APPLICATION

This application claims priority from Taiwan Patent Application No. 103210696, filed on Jun. 18, 2014, in the Taiwan Intellectual Property Office, the content of which are hereby incorporated by reference in their entirety for all purposes.

### BACKGROUND OF THE INVENTION

1. Field of the Invention

The present invention relates to a transmission line structure, in particular with respect to a transmission line structure, of which both ends are connected to signal connecting plugs, such that the transmission line structure is connected between two apparatuses or devices.

2. Description of the Related Art

The known signal transmission line is usually connected between two apparatuses or devices, and the shape thereof is mostly winded spirally as cylindrical; however, winding section of the regular signal transmission line will be deformed and is not able to recover from its cylindrical original after a long-term usage. That is to say, the above circumstances bother user under using or storing; in addition, if durability of the signal transmission line is over-emphasized, it enables the signal transmission line becoming harder and the flexibility thereof becoming worse.

According to the preceding description, the inventor of the present invention ponders on it and therefore designs a transmission line structure which aims to improve the defect of the current technique and thereby increase the industrial practicability.

### SUMMARY OF THE INVENTION

In view of the technical problem of the prior art, purpose of the present invention is to provide a transmission line structure which is designed to resolve the underperformed durability of the known signal transmission line.

According to purpose of the present invention, it provides a transmission line structure which may comprise a bandage member, at least one signal transmission line, an extrusion cover member and a temperature-resistant cover member. The bandage member which may be formed of a bendable insulating material may be shaped as a hollow conduit by winding and have a hollow accommodating space. The signal transmission line may be disposed in the hollow accommodating space by filler, and the filler may be filled between the signal wire and the bandage member. The extrusion cover member may cover an outside of the bandage member, and may be formed of a bendable plastic insulting material. The temperature-resistant cover member may cover an outside of the extrusion cover member, and may be formed of a bendable temperature-resistant material.

Preferably, the transmission line structure may further comprise a shielding member disposed between the bandage member and the extrusion cover member.

Preferably, both ends of the transmission line structure may be respectively connected to a signal connecting plug.

Preferably, the transmission line structure may have a winding section positioned between both ends of the transmission line structure.

Preferably, the extrusion cover member and the temperature-resistant cover member may be an integrated assembly.

Preferably, the bendable insulating material may be a polymeric material.

Preferably, the polymeric material may be polytetrafluoroethylene.

Preferably, the shielding member may be a metal wire.

Preferably, the shielding member may be a metal mesh.

Preferably, the shielding member may be a tin foil.

Preferably, the bendable temperature-resistant material may be a polymeric material.

Preferably, the polymeric material may be fluorine-containing rubber tube.

According to the preceding description, a transmission line structure of the present invention is to use the aforementioned structure arrangements which are an integrated assembly formed of the extrusion cover member and the temperature-resistant cover member to form an outer jacket, such that it is easy to be disposed on the transmission line structure. In addition, owing to the arrangement of the extrusion cover member and the temperature-resistant cover member, the transmission line structure is thereby of better durability and winding section thereof and even can be stretched up to two hundred thousand times. Moreover, as the arrangement of the temperature-resistant cover member, the transmission line structure thereby has a larger operating range as well as application domain, such as the application of military or industrial transmission line.

### BRIEF DESCRIPTION OF THE DRAWINGS

FIG. 1 is a structural schematic diagram of a transmission line structure according to an embodiment of the present invention.

FIG. 2 is a cross-section diagram of the transmission line structure of the present invention.

FIG. 3 is an integral schematic diagram of the transmission line structure of the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. The exemplary embodiments of the present invention will be understood more fully from the detailed description given below and from the accompanying drawings of various embodiments of the invention, which, however, should not be taken to limit the invention to the specific embodiments, but are for explanation and understanding only.

The drawings and description are to be regarded as illustrative in nature and not restrictive. Similar reference numerals designate similar elements throughout the specification.

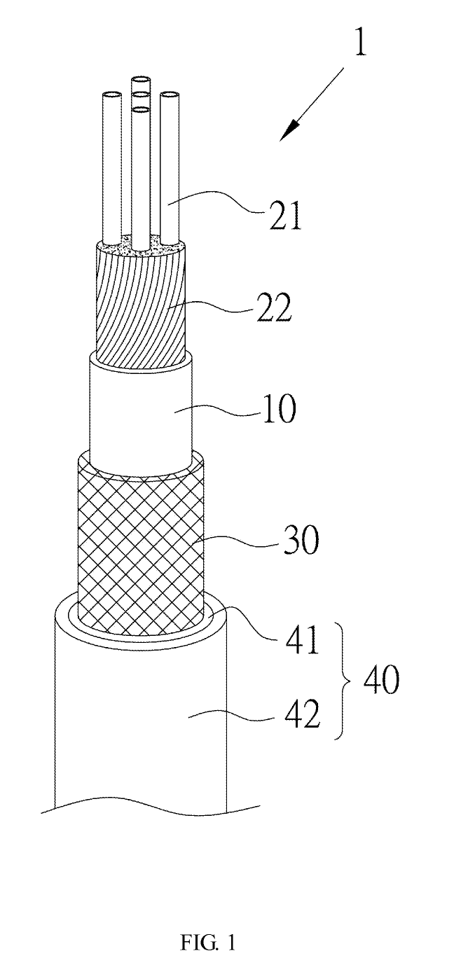

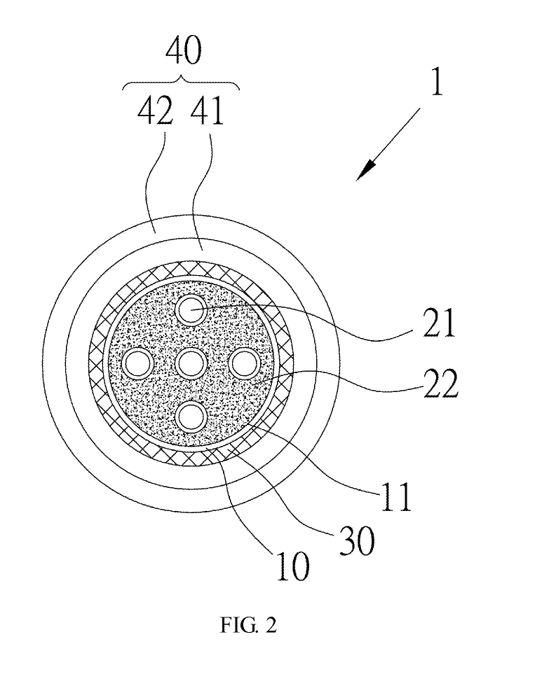

Please refer to FIGS. 1 and 2, which are a structural schematic diagram and a cross-section diagram of a transmission line structure according to an embodiment of the present invention, respectively. A transmission line structure 1 of the present invention is disposed with a signal connecting plug on both ends thereof, and is connected with devices or apparatuses by the signals connecting plug, so that it becomes an intermediary for transmitting signals between two devices or apparatuses; and preferably, the transmission line structure 1 of the present invention is applied to be an intermediary for transmitting signal between two devices or apparatuses which match up military or industrial standard. As the FIGS. show, the transmission line structure 1 of the present invention comprises a bandage member 10, a signal wire 21, a shielding member 30 and an outer jacket 40.

Wherein, the bandage member 10 is substantially shaped as a hollow conduit structure by winding such that the hollow portion forms a hollow accommodating space 11 for accommodating desirable members. In addition, the bandage member 10 is formed a bendable insulating material so as to provide the transmission line structure 1 with an adequate flexibility. Preferably, the bandage member 10 is formed of polytetrafluoroethylene (PTFE). For example, the bandage member 10 is a hollow conduit structure formed of banding polytetrafluoroethylene (PTFE TAPE).

The signal wire 21 is disposed in the hollow accommodating space 11 by filler 22, wherein the number of the signal wire 21 is decided based on the practical need, and the signal wire 21 is formed of alloy wires, such as soft copper wire, tin-plated wire, silver plated wire and so on, and insulating materials or shielding materials are added to form a cover; or one part of the signal wire 21 is formed of soft copper wire and insulating materials or shielding materials are added to form a cover and another part of the signal wire 21 is formed of alloy wire and insulating materials or shielding materials are added to form a cover. That is to say, the number of the signal line 21 is decided based on the desirable connecting advice or apparatus; namely, the number of the signal wire 21 is one to five or even more. Materials of the filler 21 is any one of kevlar, polytetrafluoroethylene (PTFE), polychlorotrifluoroethylene (PCTFE), fluorinated ethylene propylene copolymer (FEP), polyvinylidene fluoride (PVDF) or polyvinylfluoride (PVF), and preferably, it is formed of Kevlar and cotton yarn, and is filled between the signal wire 21 and the bandage member 10; and when the amount of the signal wire 21 is a plurality, the filler 22 is also filled among each signal wire 21. By the way, preferably, the arrangement of the signal wire 21 is equally distributed in the hollow accommodating space 11 and is also arranged by intertwisting so as to contribute to manufacture the transmission line structure 1.

In practical applicability, after the signal wire 21 and the filler 22 are combined, the bandage member 10 covers an outside of the combination of the signal wire 21 and the filler 22, such that the aforementioned three members are combined stably and formed a predetermined shape; for example cross section thereof is akin to a circle. However, the aforementioned order shall be not subject to this restriction.

The shielding member 30 covers outside of the bandage member 10, and is formed of a metal wire, a metal mesh or a tin foil. For example, when the shielding member 30 is a metal mesh, the mesh structure made of a plurality of copper wires, tin-plated wires, silver plated wires having the same diameter through cross weaving is disposed between the bandage member 10 and the outer jacket 40; for example, the shielding member 30 is disposed on an outer surface of the bandage member 10, or on an inner surface of the outer jacket 40. By means of arrangement of the shielding member 30, when the transmission line structure 1 of the present invention is transmitting signals, electromagnetic waves and the other noises can be effectively isolated to avoid the electrical transmission signal being interfered and the transmission quality being reduced or interrupted. In addition, under the circumstances of preventing from attenuating, aluminum foil or even copper foil is also used as metal material. However, it shall be not subject to this restriction.

It is noteworthy that in the present embodiment, although the shielding member 30 is an exemplary aspect, it can be omitted in practical applicability. For example, when transmitting low frequency signal, the shielding member 30 is selectively omitted. However, the exemplary aspect of the present invention shall be not subject to this restriction.

The outer jacket 40 covers the outside of the shielding member 30, wherein the outer jacket 40 is integrally formed of an extrusion cover member 41 and a temperature-resistant cover member 42. The extrusion cover member 41 is formed of a bendable plastic insulting material, such as Teflon (registered trademark) or polytetrafluoroethylene material, preferably ARNITEL_XG5855, to prevent from short circuit or noise and so on occurring in the transmission line structure 1. The temperature-resistant cover member 42 is formed of a bendable temperature-resistant material, and preferably, it is plastic material, such as fluorine-containing rubber tube of the temperature-resistant polymeric material (Polymar), preferably Flexible VITON Tubing, PFE TEFLON heat shrinkable tubing or PFA TEFLON heat shrinkable tubing. The extrusion cover member 41 covers the outside of the shielding member 30 and the temperature-resistant cover member 42 covers the outside of the extrusion cover member 41.

By means of arrangement of the shielding member 30, the transmission line structure 1 of the present invention can effectively isolate electromagnetic waves and the other noises, by means of the dual-layered (the extrusion cover member 41 and the temperature-resistant cover member 42) outer jacket 40, durability is thereby increased, and by mans of the temperature-resistant cover member 42, the temperature tolerance is thus enhanced, such as it can be operated at temperature between −55° C. and 200° C.

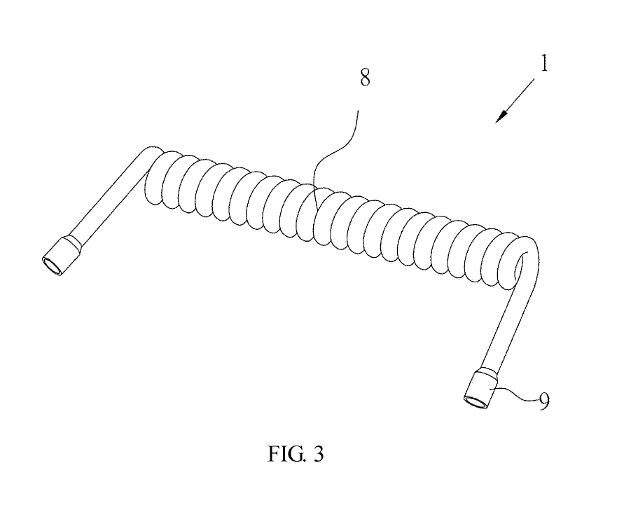

Please refer to FIG. 3 which is an integral schematic diagram of a transmission line structure of the present invention. As the FIG. shows, in practical applicability, the transmission line structure 1 of the present invention is shaped as straight or as cylindrical by spirally winding a partial section. In the present embodiment, a curling section 8 is disposed between both ends of the transmission line structure 1 is taken as an exemplary aspect, but is shall not subject to this restriction. In addition, the transmission line structure 1 of the present invention is disposed with a signal connecting plug 9, respectively, and by means of the signal connecting plug 9, the transmission line structure 1 of the present invention is connected with devices, apparatuses or any other feasible electronic devices, adequately so as to provide the signal transmission between the two electronic devices.

When the transmission line structure 1 of the present invention is applied to connecting with devices, apparatuses or any other feasible electronic devices and electrically transmitting signals, the curling section 8 of the transmission line structure 1 provides the user with random bending, turning or stretching without deforming and being not able to recover from its original shape.

In conclusion, a transmission line structure of the present invention is to use a shielding member to avoid the electrical transmission signal being interfered, resulting that the signal loses, and to reduce the loss while signal is transmitted. In addition, the transmission line structure of the present invention also uses a dual-layered (extrusion cover member and temperature-resistant cover member) outer jacket to reinforce the structure strength, stretching durability and temperature-resistant. Thus, it can be seen that the present invention has made a breakthrough and achieved the desirable effect, and those skilled in the art are not able to easily think of it; moreover, the present invention has not been disclosed prior to the filing of the patent application, and the inventiveness and applicability thereof have obviously conformed to provision for being granted for patentability, and the patent application is therefore provided.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A transmission line structure, comprising:
a bandage member formed of a bendable insulating material, shaping as a hollow conduit structure and having a hollow accommodating space;
at least one signal wire disposed in the hollow accommodating space by filler, and the filler filled between the signal wire and the bandage member;
an extrusion cover member covering an outside of the bandage member, and formed of a bendable plastic insulting material; and
a temperature-resistant cover member covering an outside of the extrusion cover member, and formed of a bendable temperature-resistant material.

2. The transmission line structure of claim 1, further comprising a shielding member disposed between the bandage member and the extrusion cover member.

3. The transmission line structure of claim 2, wherein a material of the shielding member is a metal wire.

4. The transmission line structure of claim 2, wherein a material of the shielding member is a metal mesh.

5. The transmission line structure of claim 2, wherein a material of the shielding member is a tin foil.

6. The transmission line structure of claim 1, wherein both ends of the transmission line structure are respectively connected to a signal connecting plug.

7. The transmission line structure of claim 1, wherein the transmission line structure has a winding section positioned between both ends of the transmission line structure.

8. The transmission line structure of claim 1, wherein the extrusion cover member and the temperature-resistant cover member are an integrated assembly.

9. The transmission line structure of claim 1, wherein the bendable insulating material is a polymeric material.

10. The transmission line structure of claim 9, wherein the polymeric material is polytetrafluoroethylene.

11. The transmission line structure of claim 1, wherein the bendable temperature-resistant material is a temperature-resistant polymeric material.

12. The transmission line structure of claim 11, wherein the temperature-resistant polymeric material is fluorine-containing rubber tube.
